(19) United States
(12) Patent Application Publication
(10) Pub. No.: US 2007/0270044 A1
(43) Pub. Date: Nov. 22, 2007

(54) High Speed Modular Jack

(76) Inventors: Yakov Belopolsky, Harrisburg, PA (US); David Gutter, Felton, PA (US); Richard Marowsky, York, PA (US)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/748,688

(22) Filed: May 15, 2007

Related U.S. Application Data
(60) Provisional application No. 60/747,534, filed on May 17, 2006.

(51) Int. Cl. H01R 24/00

(52) U.S. Cl. 439/676

(57) ABSTRACT

A jack capable of handling both Category 6 and Category 7 communications. The jack comprises a shield and a housing inside the shield. Eight contacts are disposed on a first side of the housing, each contact including a contact portion effective to touch a corresponding contact of a plug when the plug is inserted into the jack, and a first end portion effective to be inserted into a circuit board. Four contacts are disposed on a second side of the housing opposite the first side, each contact including a contact portion effective to touch a corresponding contact of a plug when the plug is inserted into the jack, and a first end portion effective to be inserted into a circuit board. The first ends of the first contacts and the second contacts exit the second side of the housing. A shield is disposed between the contacts on the first side of the housing and between the contacts on the first side of the housing and contacts on the second side of the housing. An additional shield includes spring members extending inwardly so as to engage a corresponding shield of an inserted plug.

This application claims priority to provisional application No. 60/747,534 entitled “HIGH SPEED MODULAR JACK” filed May 17, 2006, the entirety of which is hereby incorporated by reference.

### BACKGROUND OF THE INVENTION

The invention relates to a modular jack and, more particularly, to a modular jack which may be compliant with multiple communication standards and/or which includes improved noise compensation abilities.

The use of modular plugs and jacks for data transmission is known. Basically, in order to establish electrical communication and a data path between a first and second device, the first device may send information in the form of electrical signals out into a cable that terminates in a plug. The second device may include a jack. The plug and jack are designed so as to be easily mechanically mate-able in a male-female configuration. Once the plug and jack are mated, electrical members in the plug and connector engage and are electrically mated so that electrical information signals may travel from the first device to the second device.

This plug and jack design is limited by the physical configuration of the modular plug and jack. As data transmission speeds have increased, electrical performance relating to the transfer of electrical signals from plug to connector, has been affected. Each plug and jack frequently includes multiple pairs of contacts used to communicate information. Cross talk between these pairs (where electrical signals in one pair affect electrical signals in another pair) and interference from sources external to the plug-jack configuration, become more of a factor at higher speeds. In order to carry the higher speed data without signal degradation, the plug and jack design changed to include compensation circuitry such as that used to balanced impedance in transmission lines.

Standards organizations such as the Telecommunication Industry Association and the International Organization for Standardization publish standards regarding performance specifications and equipment configurations for plugs and jacks. Different levels or “categories” have been defined for use in twisted-pair cabling such as where a single insulated sheath includes two twisted wires. For example, “Category 6” plugs and jacks should be able to handle data communications with a frequency up to 250 MHz. Category 6 plugs typically have eight contacts aligned in a row on one side of the plug. More recent requirements, e.g. Category 7, require plugs and jacks which can communicate at speeds as high as 600 MHz.

The balanced line compensation approach discussed above proved acceptable for performance levels up to Category 6 i.e., 250 MHz. In order to meet the electrical requirements of the transmission speeds specified in Category 7, the cross talk and interference generally could not be canceled out using only balanced line compensation and so the contacts were moved to opposite sides of the plug and jack. As the industry is evolving from Category 6 to Category 7 usage, it is desirable to provide a jack that can receive and communicate with plugs using either standard. Providing such a connector is difficult because while eight (8) coplanar contacts had been used in Category 6 applications, in Category 7, the eight contacts are spaced in two different planes on opposite sides of the jack so as to minimize crosstalk between signal pairs.

An example of a prior art jack which may be used for both Category 6 and Category 7 communications is shown in U.S. Pat. No. 6,739,892 and is reproduced in part, in FIG. 1. Referring to FIG. 1, a prior art connector 50 consists of a shield 52, a dielectric housing 54, a switch insert 56 and a circuit board sub-assembly 58. When assembled, sub-assembly 58 is inserted into switch insert 56, switch insert 56 is inserted into housing 54, and housing 54 is inserted into shield 52. When a Category 6 plug is inserted into jack 50, terminals on sub-assembly 58 engage corresponding terminals of the plug for data communication. If a Category 7 plug is inserted into jack 50, a protrusion on the plug engages a switch 60 on switch insert 56. Switch 60 causes some of the terminals in connector 50 to be lifted away from electrical connection and moved into contact with a grounding member (not shown).

There are problems with the prior art connector shown in FIG. 1. Requiring a switch to disengage or ground some of the terminals increases the complexity of the device. Moreover, there is the possibility of an open circuit especially if there is a failure in the switch.

### SUMMARY OF THE INVENTION

One embodiment of the invention is a jack comprising a housing and at least two first contacts on a first side of the housing, each first contact including a contact portion effective to touch a first corresponding contact of a plug when the plug is inserted into the jack, and an end portion effective to be attached to an electronic circuit. The jack further comprises at least two second contacts on a second side of the housing opposite the first side, each second contact including a contact portion effective to touch a second corresponding contact of a plug when the plug is inserted into the jack, and an end portion effective to be inserted into a circuit board; wherein the ends of the first contacts and the second contacts exit the second side of the housing. The jack further comprises a shield disposed in the housing between the two first contacts.

Another embodiment of the invention is a jack comprising a housing and at least eight first contacts on a first side of the housing, each first contact including a contact portion effective to touch a first corresponding contact of a plug when the plug is inserted into the jack and an end portion effective to be attached to an electronic circuit. The jack further comprises at least four second contacts on a second side of the housing opposite the first side, each second contact including a contact portion effective to touch a second corresponding contact of a plug when the plug is inserted into the jack, and an end portion effective to be inserted into a circuit board; wherein the ends of the first contacts and the second contacts exit the second side of the housing in first, second, third, and fourth distinct planes, the first plane including the ends of two of the second contacts, the second plane including the ends of another two of the second contacts, the third plane including the ends of four of the first contacts, the fourth plane including the ends of another four of the first contacts.

Another embodiment of the invention is a jack comprising a shield including a base and at least one spring member extending toward an inside of the base, the spring member disposed so as to touch a plug shield of a plug when the plug is inserted into the jack. The jack further comprises a housing in the shield and at least two first contacts on a first side of the housing, each first contact including a contact portion effective to touch a first corresponding contact of a plug when the plug is inserted into the jack, and an end portion effective to be attached to an electronic circuit. The jack further comprises at least two second contacts on a second side of the housing opposite the first side, each second contact including a contact portion effective to touch a second corresponding contact of a plug when the plug is inserted into the jack, and an end portion effective to be inserted into a circuit board.

Another embodiment of the invention is a method for inserting plugs into a jack, the method comprising inserting a first plug including eight contacts all aligned on a first side of the plug into the jack by touching the contacts of the first plug with contacts of the jack, the jack including eight contacts on a first side of the jack and four contacts on a second side of the jack, the contacts of the jack on the first and second sides all having distinct voltage potentials when the plug is not sending electrical signals to the jack. The method further comprises removing the first plug and inserting a second plug including contacts aligned on first and second sides of the plug into the jack by touching contacts of the second plug with the contacts of the jack.

### BRIEF DESCRIPTION OF THE DRAWINGS

FIG. 1 is a side perspective cut-away view of a jack in accordance with the prior art.

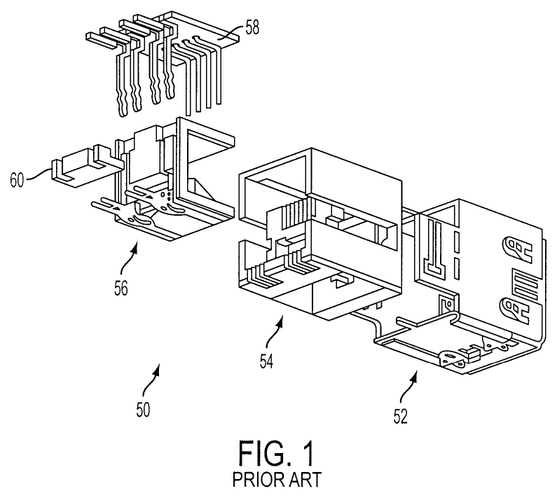

FIG. 2 is a side perspective cut-away view of a jack in accordance with an embodiment of the invention.

FIG. 3 is a magnified side perspective cut-away view of a combination plug and jack in accordance with an embodiment of the invention.

FIG. 4 is a side perspective cut-away view of a jack in accordance with an embodiment of the invention.

FIG. 5 is a bottom perspective cut-away view of a jack in accordance with an embodiment of the invention.

FIG. 6 is a rear perspective cut-away view of a jack in accordance with an embodiment of the invention.

FIG. 7 is a side perspective cut-away view of a jack in accordance with an embodiment of the invention.

FIG. 8 is a side perspective cut-away view of a jack in accordance with an embodiment of the invention.

FIG. 9 is a side perspective cut-away view of a jack in accordance with an embodiment of the invention.

FIG. 10 is a side perspective view of a jack in accordance with an embodiment of the invention.

FIG. 11 is a side perspective view of a jack in accordance with an embodiment of the invention.

FIG. 12 is a side perspective view of a jack in accordance with an embodiment of the invention.

FIG. 13 is a front perspective view of a jack in accordance with an embodiment of the invention.

FIG. 14 is a front perspective view of a jack in accordance with an embodiment of the invention.

FIG. 15 is a front cut-away view of a jack in accordance with an embodiment of the invention.

FIG. 16 is a side cut-away view of a jack in accordance with an embodiment of the invention.

FIG. 17 is a chart detailing particular measurements which could be used in constructing an embodiment of the invention.

FIG. 18 is a chart detailing particular measurements which could be used in constructing an embodiment of the invention.

FIG. 19 is a side perspective cut-away view of a jack in accordance with an embodiment of the invention.

FIG. 20 is a front perspective cut-away view of a jack in accordance with an embodiment of the invention.

FIG. 21 is a side perspective cut-away view of a housing which could be used in accordance with an embodiment of the invention.

FIG. 22 is a circuit diagram along with tolerances for circuit elements which could be used in accordance with an embodiment of the invention.

FIG. 23 is a bottom perspective view of a jack in accordance with an embodiment of the invention.

### DETAILED DESCRIPTION OF THE PREFERRED EMBODIMENT(S)

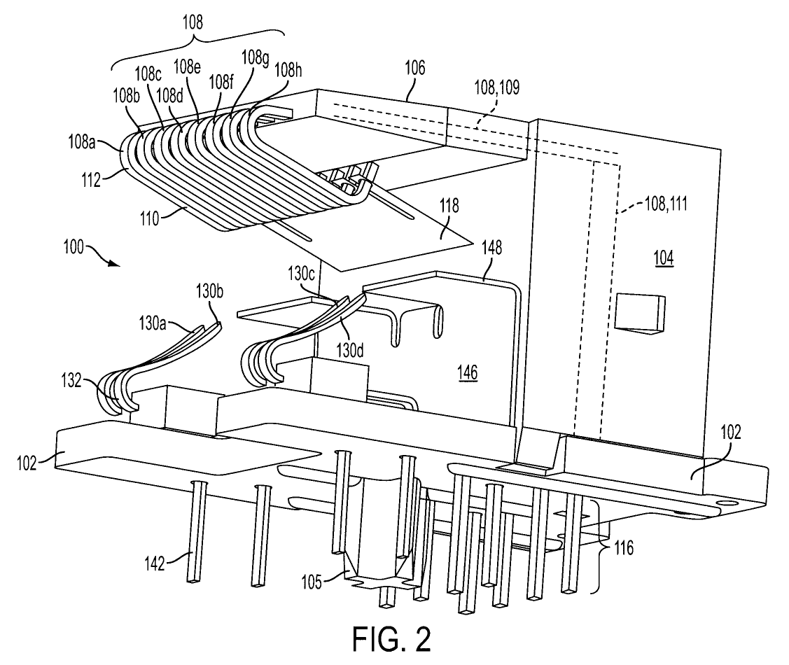

Referring to FIG. 2, there is shown a jack 100 in accordance with an embodiment of the invention with a portion of the housing removed. Jack 100 is capable of communicating with a plug (not shown) using Category 6, Category 6A, Category 7, Category 7A communication standards as well as other communication standards. Jack 100 includes a base 102 on which elements of jack 100 are mounted. A post 105 having a cross-shaped cross-section extends from a bottom of base 102 and may be used to mechanically mount jack 100 to a circuit board (not shown). Although shown on a bottom of jack 100, post 105 could be disposed on a top of jack 100 and used to mount jack 100 to a circuit board from either above, below, to the side or oblique to jack 100.

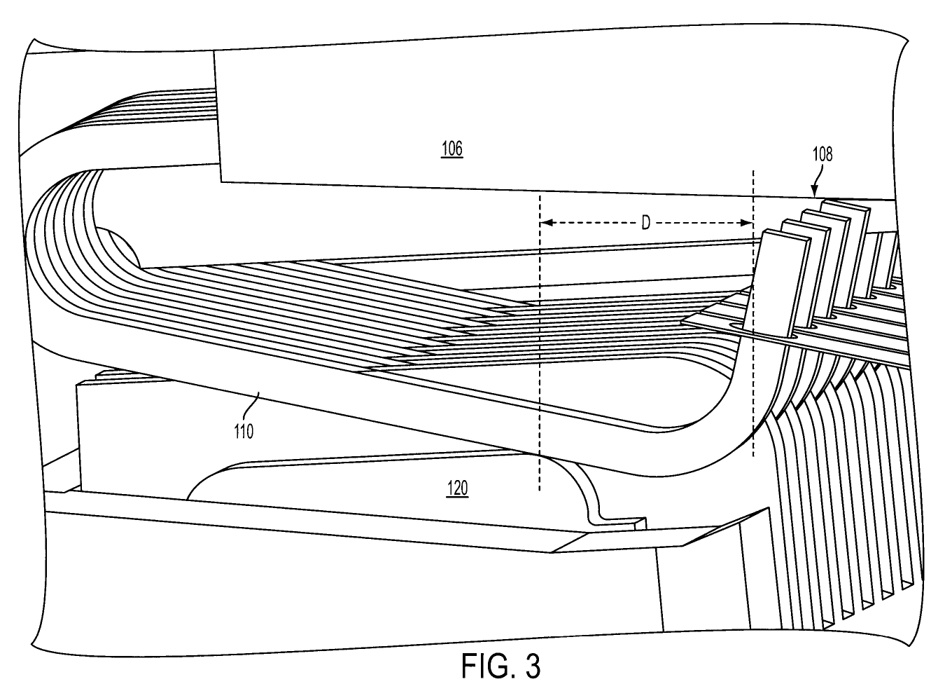

Jack 100 includes a pass-through housing 104 (which may include a removable cover with recesses) mounted on base 102. As discussed below, pass-through housing 104 may be used to provide a pathway for contacts to pass through to base 102. Housing 104 includes a cantilevered support 106. Support 106 supports upper contacts 108. As shown, eight (8) upper contacts 108a, 108b, 108c, 108d, 108e, 108f, and 108g may be used as is customary in RJ45 type jacks when communicating at Category 6 or 6A speeds and configurations. Upper contacts 108 include contact portions 110 which physically touch contacts of an inserted plug (partially shown in FIG. 3). Upper contacts 108 further include an arcuate connecting portion 112 fixed at one end to support 106. Contact portions 110 extend downward into a plug-receiving area of jack 100 and terminate at first ends 114. First ends 114 are coupled to a flexible substrate 118 on which a compensation circuit is provided. As shown, flexible substrate 118 includes longitudinally extending recesses which mate with first ends 114.

Upper contacts 108 further include bridge portions 109 that extend through the cantilevered support 106 (e.g. are insert molded therein), and vertical terminal portions 111 that extend through pass-though housing 104 and though base 102—both shown in dotted lines. Upper contacts 108 exit from base 102 to form pins 116 to provide electrical communication with a circuit board (not shown). Pins 116 exit base 102 in two planes as shown.

Flexible compensation circuitry 118 may be used to cancel out interference between neighboring pairs of contacts 108, reduce cross-talk between contacts 108, or to balance a cable terminating in jack 100. A circuit including capacitors electrically connecting neighboring contacts 108 may be used. For example, referring to contacts 108a-108h as first though eighth, respectively, between a third and a fifth contact 108, a capacitor with a value in a range of approximately 300 to 3600 fF could be used; between a fourth and a sixth contact 108, a capacitor with a value in a range of approximately 300 to 3600 fF could be used; between a first and a third contact 108, a capacitor with a value in a range of approximately 0 to 2400 fF could be used; between a second and a sixth contact 108, a capacitor with a value in a range of approximately 0 to 2100 fF could be used; between a third and a seventh contact 108, a capacitor with a value in a range of approximately 0 to 2100 fF could be used; between a sixth and an eighth contact 108, a capacitor with a value in a range of approximately 0 to 2400 fF could be used. Other arrangements and capacitance values are within the scope of the invention.

Referring to FIG. 3, there is shown an enlarged cut-a way view of the connection between flexible compensation circuitry 118 and contacts 108. As shown, when a plug with a blade-like contact 120 is inserted into jack 100, plug blade 120 communicates electrically with one of contacts 108. Flexible compensation circuit 118 is soldered at circuit contacts 124 to the ends of contacts 108. The connection is designed to minimize the distance D between the point 126 of the plug-jack contact and the connection of the jack contact to the circuit 118 to minimize signal degradation. Flexible compensation circuit 118 has a flexible substrate so that when plug blades 120 engage the contact portions 110 (thereby flexing contacts 108 around arcuate portions 112), the circuit substrate 118 will also flex and/or move to allow for such insertion but still remain connected to contacts 108.

Referring again to FIG. 2, jack 100 may be used to provide electrical connection with a plug using Category 6 communication. Upper contacts 108 enable such communications. Jack 100 further allows for communication using Category 7 speeds and corresponding plugs. Such plugs have blade-like contacts disposed on both a top and a bottom of the plug. To accommodate such plugs, jack 100 includes bottom contacts 130 on a side of jack 100 opposite contacts 108. As shown, four bottom contacts 130a, 130b, 130c, and 130d, are arranged in two pairs on a bottom of jack 100 opposite upper contacts 108.

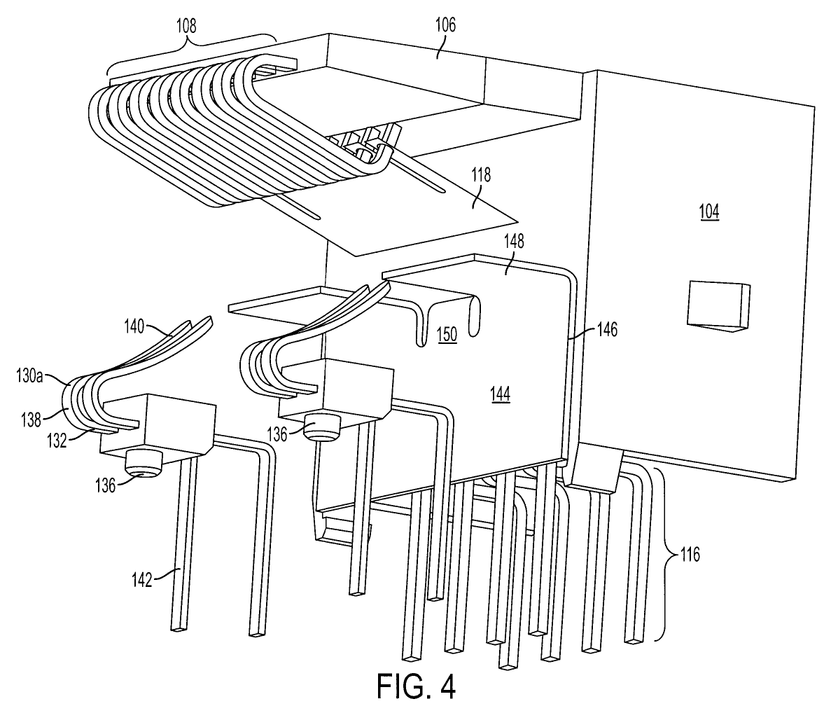

Each bottom contact 130 includes a base portion 132 fixedly mounted to a mounting member 134. For simplicity, explanation will be made with respect to bottom contact 130a though it should be clear that all bottom contacts 130 are similarly structured. As shown most clearly in FIG. 4 (where base 102 has been removed for clarity), mounting member 134 has a downwardly extending cylindrical shaped projection 136. Projection 136 may be used to mate with a corresponding recess in base 102. Bottom contacts 130 further include an arcuate portion 138 and terminate at a first contact portion 140. First contact portion 140 is spring biased upwardly at arcuate portion 138 so as to enhance electrical and mechanical communication with an inserted plug. Bottom contacts 130 have vertical portions which project through the base 102 (FIG. 3) to form pins 142 which communicate with a circuit board (not shown). Pins 142 exit base 102 in two planes as shown.

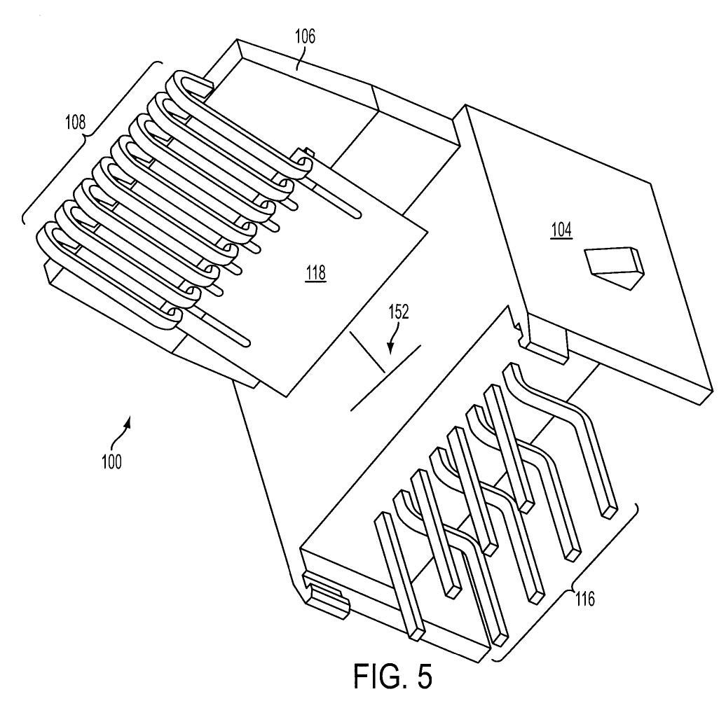

Referring to both FIGS. 2 and 4, an L-shaped shield 144 made of a metallic material is mounted to housing 104. Shield 144 includes a base portion 146 extending parallel to the pins 116 of upper contacts 108 and to pins 142 of lower contacts 130. Shield 144 further includes a flange 148 extending perpendicular to base 146. Shield 144 includes a tab 150 extending parallel to flange 148 but in an opposite direction from flange 148. Tab 150 may be used to mount shield 144 to housing 104 through a T-shaped recess 152 shown in FIG. 5.

Shield 144 provides desirable shielding for jack 100 when used with Category 7 communications. Base 146 of shield 144 provides shielding between bottom contacts 130 and the vertical portions 111 of top contacts 108 that extend through through-housing 104. Further, flange 148 provides shielding between bottom contacts 130 and top contacts 108 in an area where a plug is inserted into jack 100.

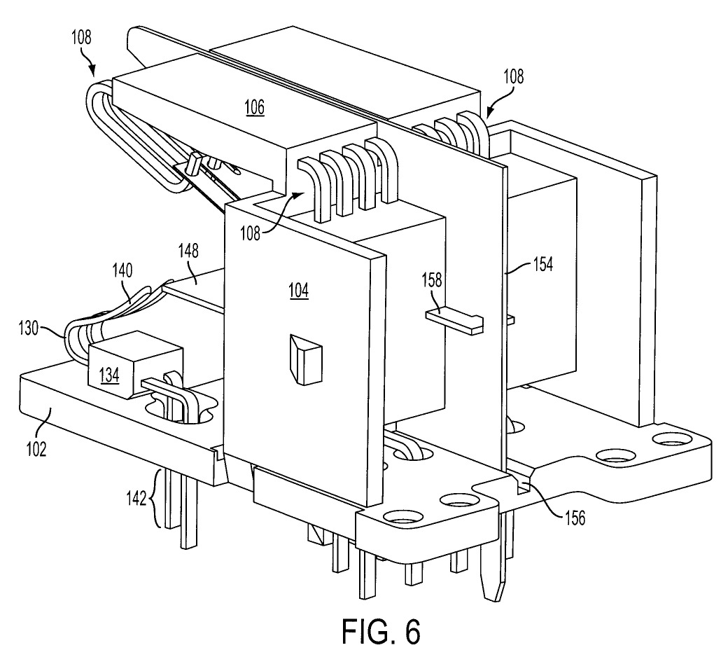

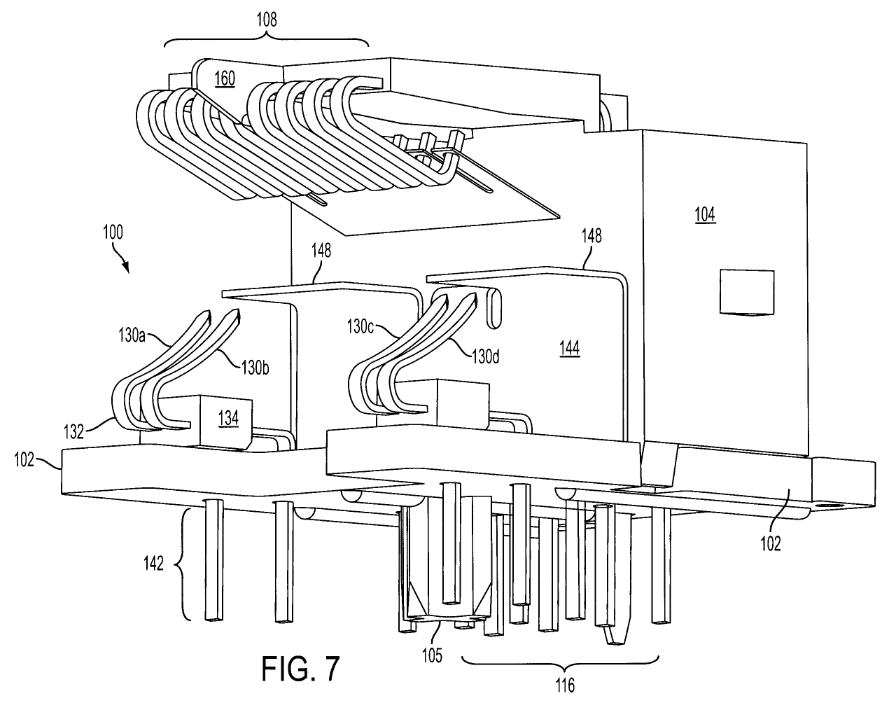

When using Category 7 communications, laterally disposed pairs of upper contacts 108a, 108b, 108g and 108h are used. Referring to FIG. 6, to further shield signal pairs in these upper contacts from each other, a vertical shield 154 may be used to shield communications between upper contacts 108a, 108b and contacts 108g, 108h (contacts shown most clearly in FIG. 2) as the vertically extending contact portions 110 (FIG. 2) of these contacts extend on either sides of shield 154. Of upper contacts 108, only contacts 108a, 108b, 108g and 108h are used for Category 7 communications. The vertical shield 154 may be made of a metallic material and may be mounted in a rear of housing 104 in a recess 156 and in a support 158. Referring also to FIG. 7, an additional vertical shield 160 may be mounted on support 106 between upper contacts 108d and 108e. Again, shield 160 is made of a metallic material and serves to shield upper contacts 108a, 108b from upper contact 108g, 108h when Category 7 communications are used. As discussed, when Category 7 communications and plugs are used, shields 144, 154 and 160 may be used to shield communication between respective upper and lower contacts 108, 130.

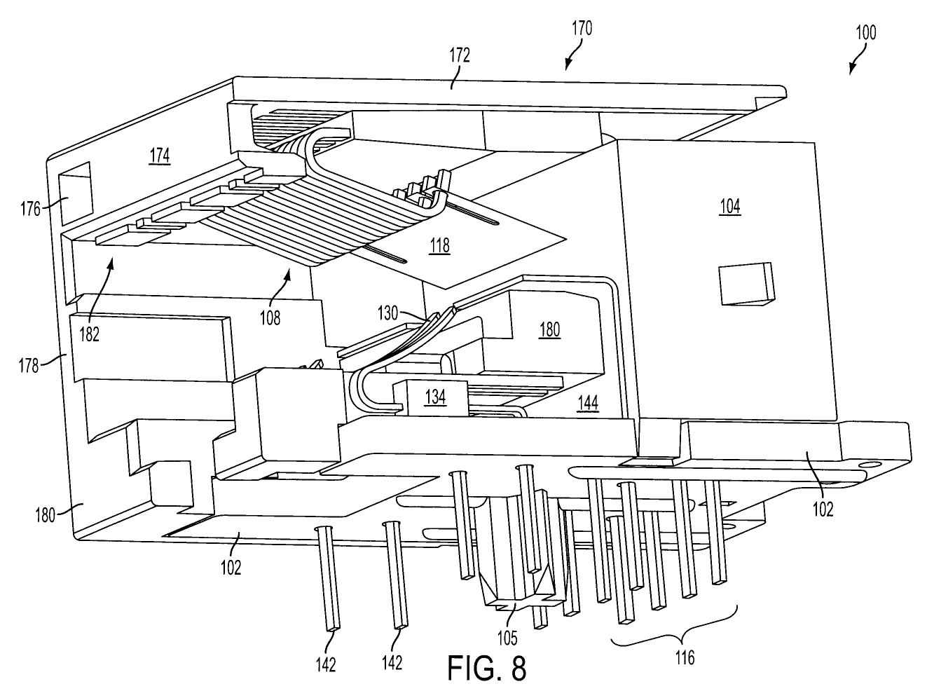

Now that the arrangement of the contacts for connecting the jack with a plug and the shielding of these contacts has been described, the housing and external shielding of jack 100 will be explained. Referring now to FIG. 8, a housing 170 of jack 100 includes a top 172, a top front 174, a bottom front 180 and sides 178. Note that FIG. 8 is a cut-away view of housing 170 and only one side 178 is shown. Top front 174 includes cavities 176 for receiving optical light pipes discussed below. Top front 174 further includes a flat frame portion 182 used to help define an insertion area 184 for a plug (not shown) to be inserted. Bottom front 180 of housing 170 has a stepped cross-section typical for receiving modular plugs. Flat frame portion 182, in combination with sides 178 and bottom front 180 define a plug-receiving cavity 184. Cavity 184 is defined so as to be capable of receiving both Category 6 and Category 7 plugs.

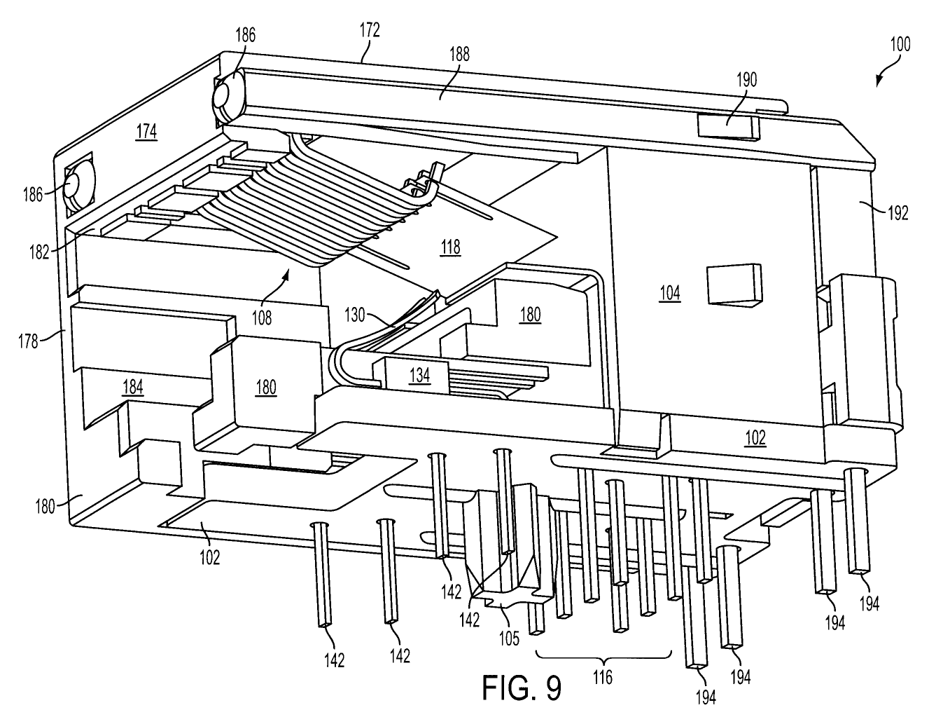

Referring to FIG. 9, more detail of housing 170 is shown including the provision of optical light pipes. As shown in the figure, optical light pipes 188 may be inserted into a longitudinal opening defined by housing 170. The openings terminate at ends of housing 170 and form cavities 176 defined by top front portion 174. Each optical light pipe 188 includes an exposed end 186 situated in a respective cavity 176. LEDs 192 are disposed at a rear of housing 170 and include LED terminals 194 extending downwardly. LEDs 192 are in optical communication with light pipes 192 so that light emitted from LEDs 192 may travel through light tubes 192 and be visible at ends 186. Such light may indicate that jack 100 is receiving power and/or indicate that jack 100 is receiving or transmitting information or simply connected to a plug. Light pipes 188 include outwardly biased flanges 190 used to connect light pipe 188 to housing 170. Flange 190 is discussed in more detail below. A rear support 193 is used to retain LEDs 192 and terminals 194 on housing 170 and to provide further structural support for housing 170.

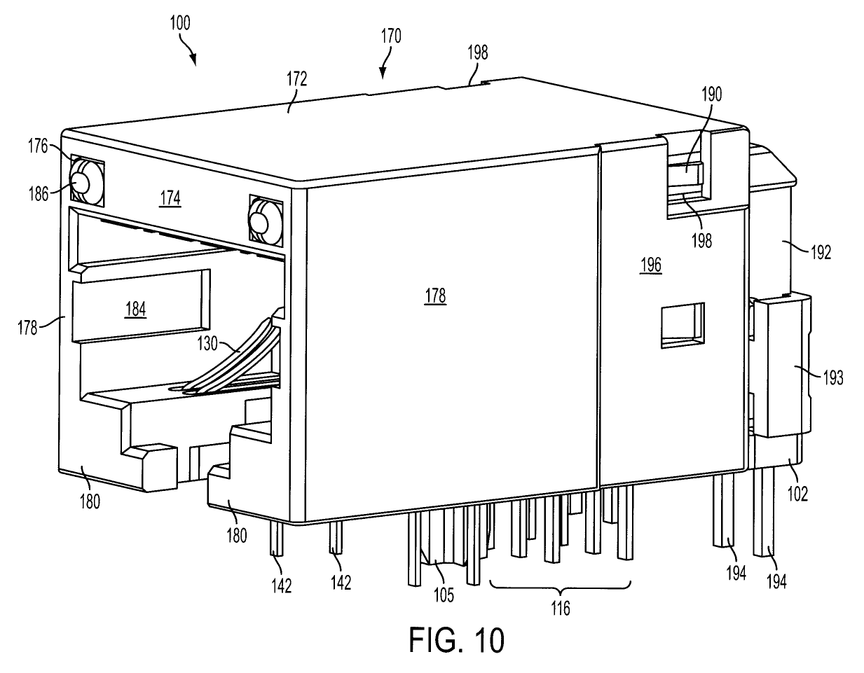

Referring to FIG. 10, there is shown a view of the entire housing 170. As shown, sides 178 of housing 170 further include rear portions 196. Rear portions 196 define openings 198 for receiving the flanges 190 of light tubes 188. In this way, light tubes 188 may be inserted from a rear of housing 170 toward front 174, 180 of housing. A user inserting tubes 188 into housing 170 causes outward biased flange 190 to bend inwardly. Once flange 190 of light tube 188 reaches opening 198, flange 190 again extends outwardly thereby maintaining tube 188 in housing 170. To replace tube 188, a user may push flange 190 inward and then push tube 188 to the rear of housing 170.

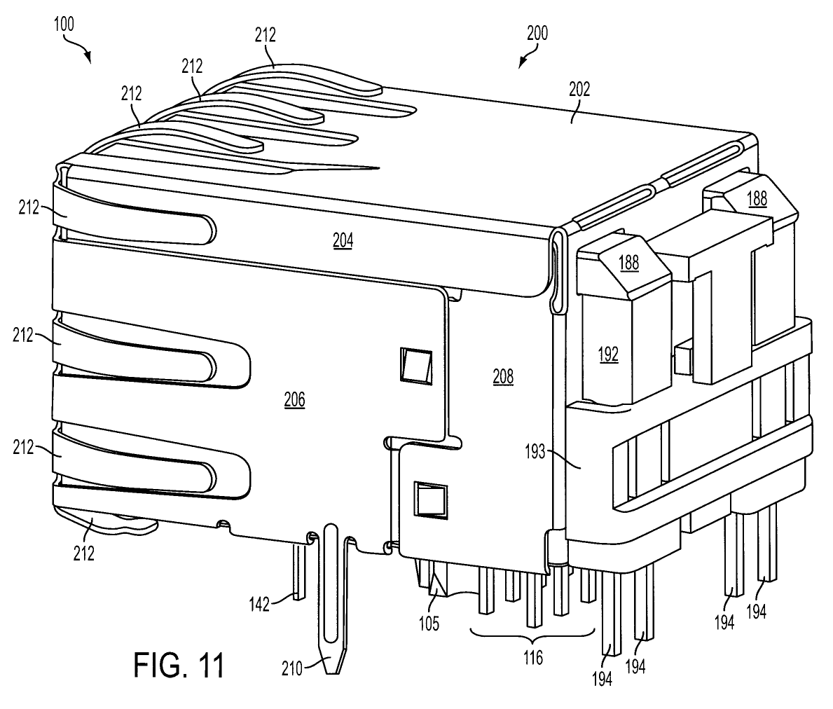

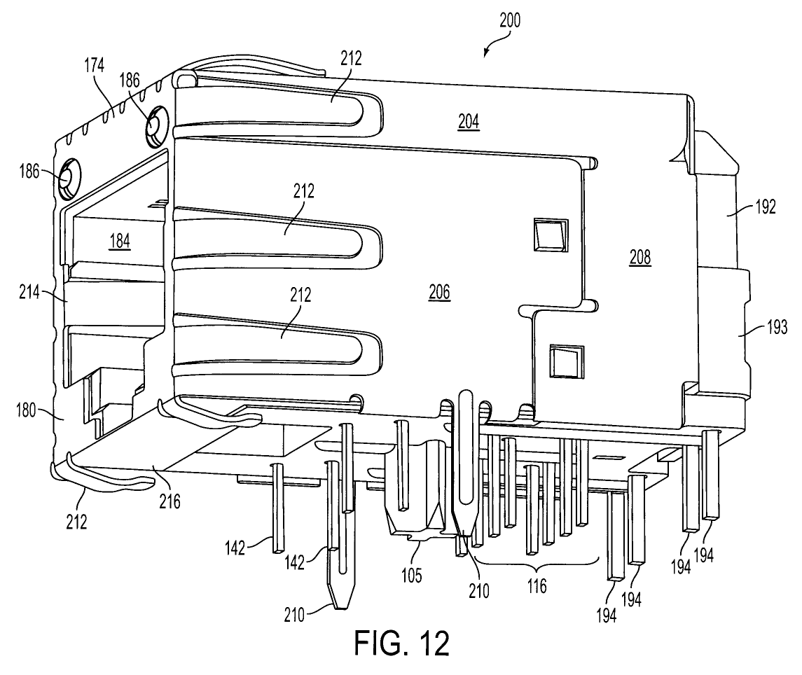

Referring to FIGS. 11-14, there is shown an external shield 200 which may be used with jack 100. Shield 200 includes a base including a top portion 202, lips 204 which extend from top 202 to sides of jack 100, side front portions 206, side rear portions 208, and a front face 218. Side front portions 206 terminate in ground connectors 210. Ground connectors 210 may be used to ground shield 200 to a circuit board. Shield 200 includes spring members 212 extending outward from top 202, sides 206, 208 and a bottom 216 of shield 200. Spring members 212 are effective to engage a grounding member (not shown) of a chassis (not shown) when jack 100 is inserted into the chassis.

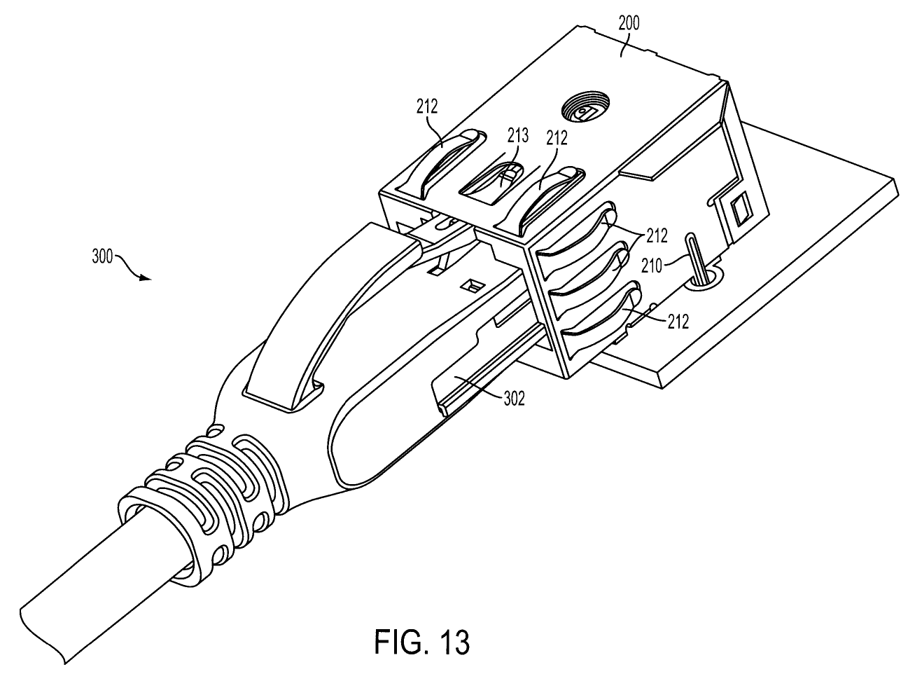

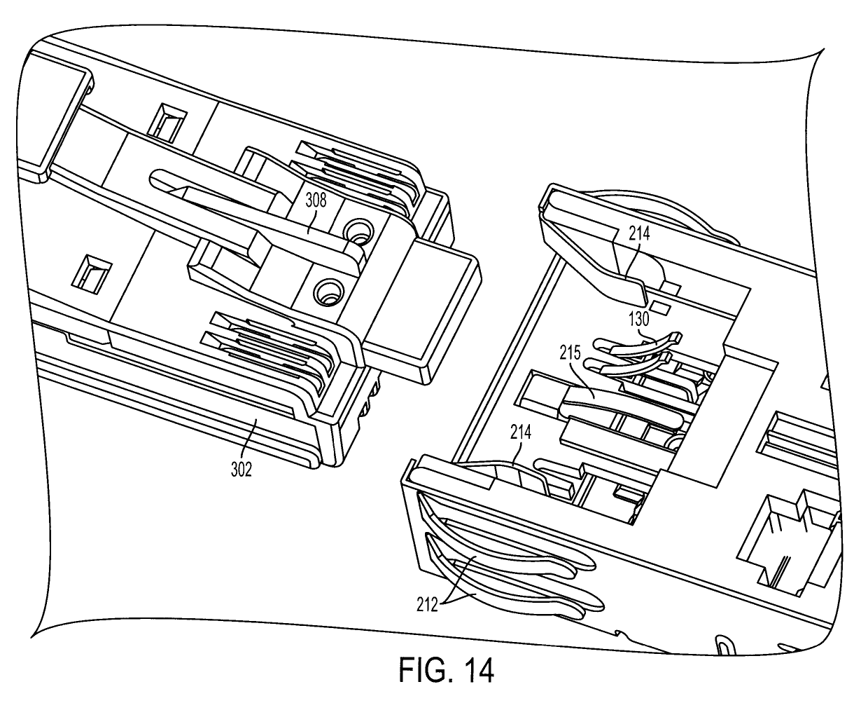

Focusing on FIGS. 13 and 14, there is shown a plug 300 mating with jack 100. These figures highlight how shield 200 of jack 100 provides grounding for an inserted plug. A top spring 213 (FIG. 13) of shield 200 touches a point 308 (FIG. 14) of shield 302 of plug 300. Further, spring member 214 of shield 200 touch sides of shield 302 of plug 300. Finally, a bottom spring 215 of shield 200 touches a bottom of shield 200. In this way, shield 302 of plug 300 is brought to the same potential as shield 200.

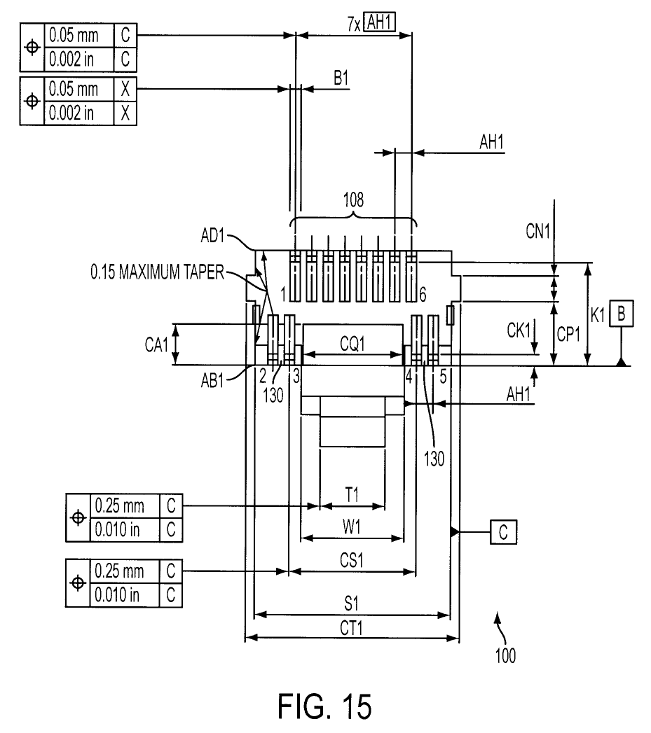

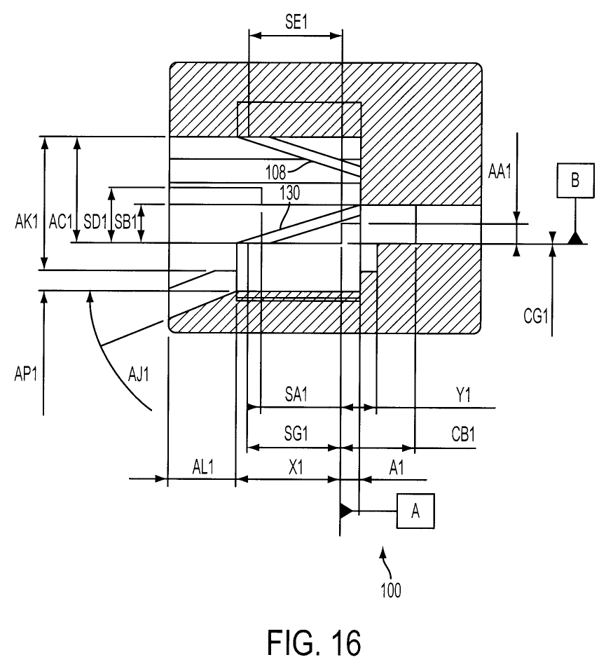

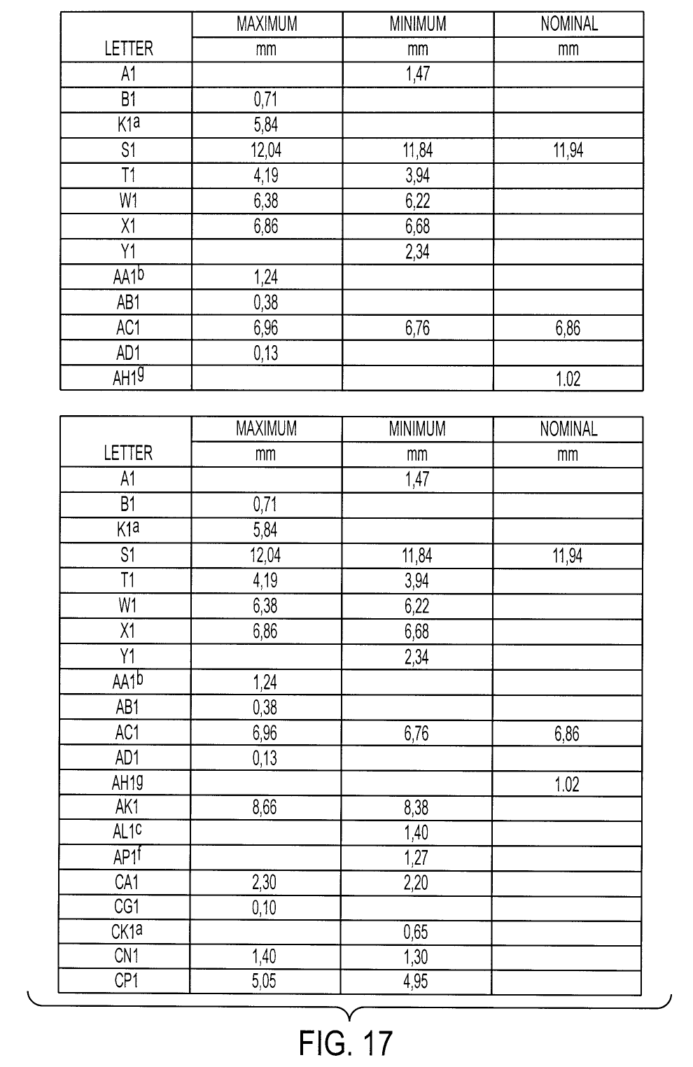

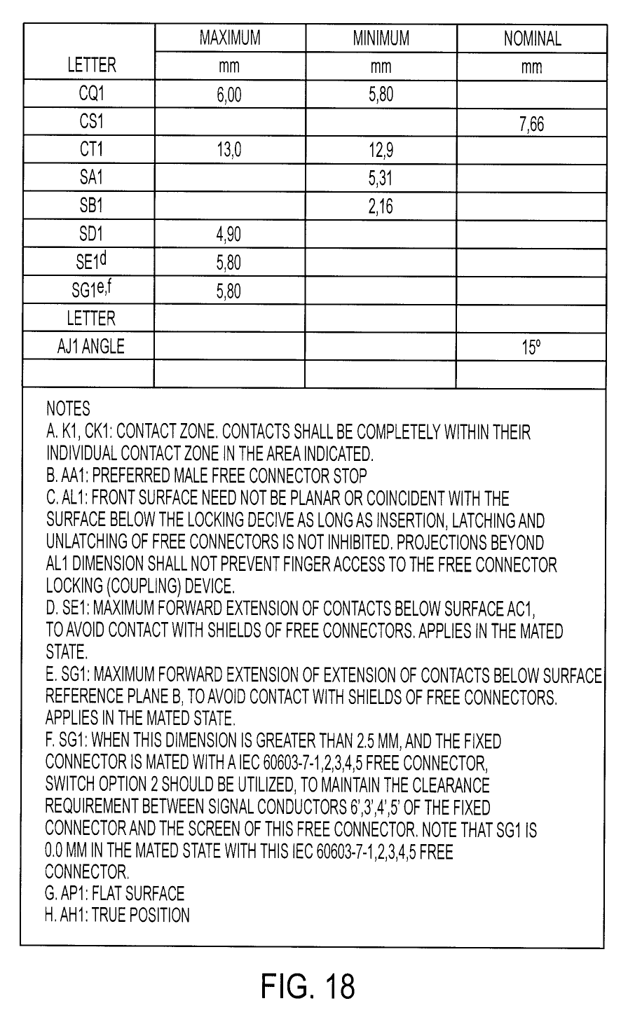

Referring to FIGS. 15-18, there are shown various dimensions for the spacing of contacts on Category 7 jacks. FIG. 15 is a front cut-away view of a Category 7 jack and FIG. 16 is a side cut-away view of Category 7 jack. FIGS. 17 and 18 are charts listing some of the preferred dimensions for the various structures though it should be clear that other dimensions could be used and would be within the scope of the invention.

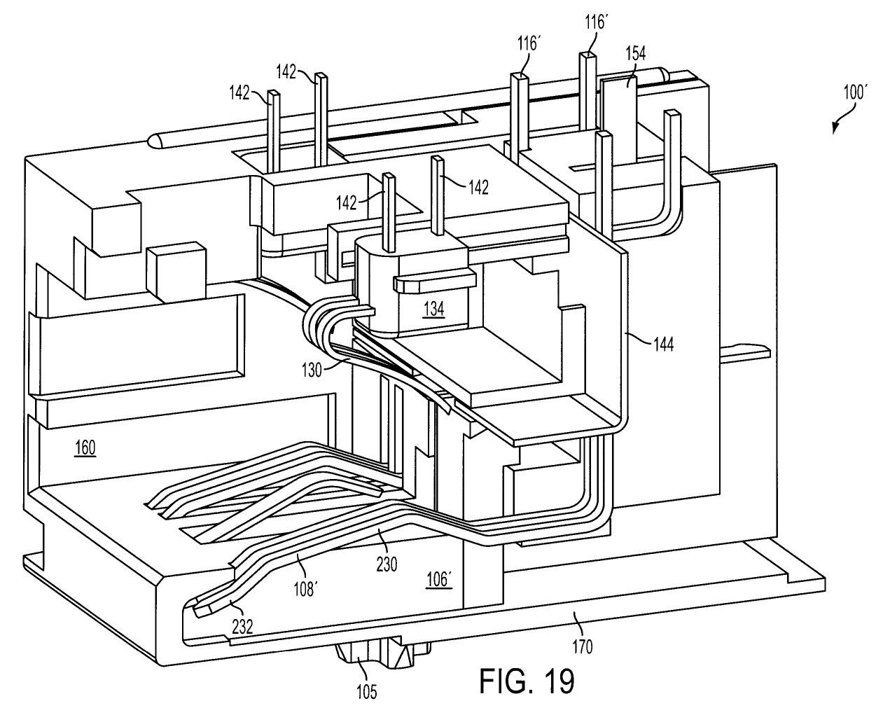

Referring to FIG. 19, there is shown another embodiment of the invention. In FIG. 19, a jack 100′ includes many of the same components as jack 100 and a detailed description of these components is therefore omitted. For example, shield 154 may be used with jack 100′. Jack 100′ includes upper contacts 108′ (shown at a lower portion of the figure) shaped differently from upper contacts 108 of jack 100. Contacts 108′ include contact portions 230 effective to communicate with contacts of a plug (not shown) and a base portion 232. Base portion 232 is captured under a lip of base portion 106′. Upper contacts 108′ continue through pass through housing 104 and terminate at pins 116′. In this embodiment, mounting post 104 is disposed distal from both terminals 142 of lower contacts 130 and terminals 116′ of upper contacts. The use of the terms “upper” and “lower” are for convenience only and can be used interchangeably. For example, mounting post 104 may be used to mount jack 100 or jack 100′ from above or from below. In the embodiment of FIG. 19, all of terminals 142 and 116′ from both lower contacts 130 and upper contacts 108′ emerge at the top of jack 100′. The structures shown for upper contacts 130 and for mounting post 104′ could be used with any of the previously described embodiments.

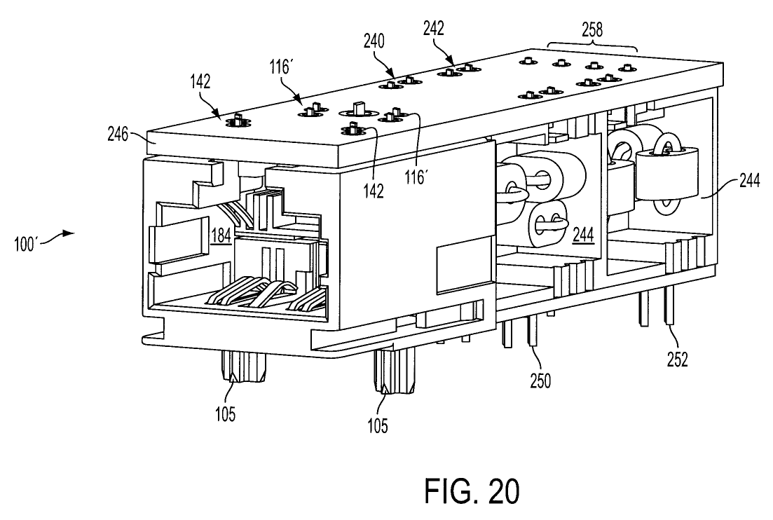

Referring to FIG. 20, there is shown a more complete view of jack 100′. As shown, jack 100′ includes an upper printed circuit board 246 from which terminals 142 and 116′ of both lower contacts 130 and upper contacts 108′ extend. Also extending from upper circuit board 246 are input terminals 240 and 242 which are in electrical communication (circuitry not shown) with ends 142 and 116′. Terminals 240 and 242 are connected to magnetic filter circuits 244. Magnetic filter circuits 244 may be used to remove spurious signals moving through jack 100′ and/or may be used to remove any signal interference such as that caused by electromagnetic waves incident upon jack 100′. As shown, two input terminals 240 and two input terminals 242 are connected to respective magnetic filter circuits 244—i.e. there are four magnetic filter circuits, each with its own set of cores. An output of the magnetic filter circuits 244 is fed to output terminals 250 and 252 respectively.

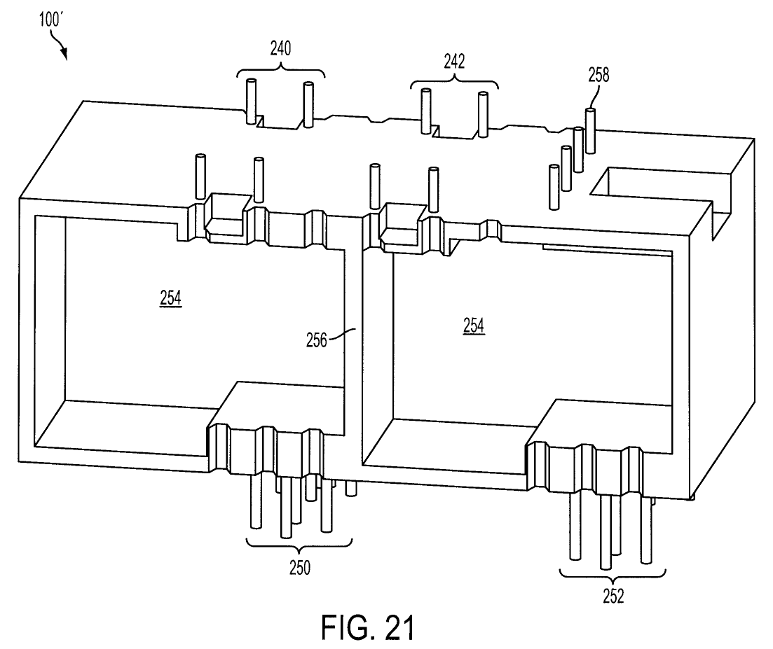

Referring to FIG. 21, each magnetic filter circuit 244 is disposed in its own filter cavity 254. A housing divider 256 disposed on either side of jack 100′ separates and defines these cavities. Jumper pins 258 extend away from upper circuit board 246 and are used to provide electrical communication to magnetic filter circuits 244.

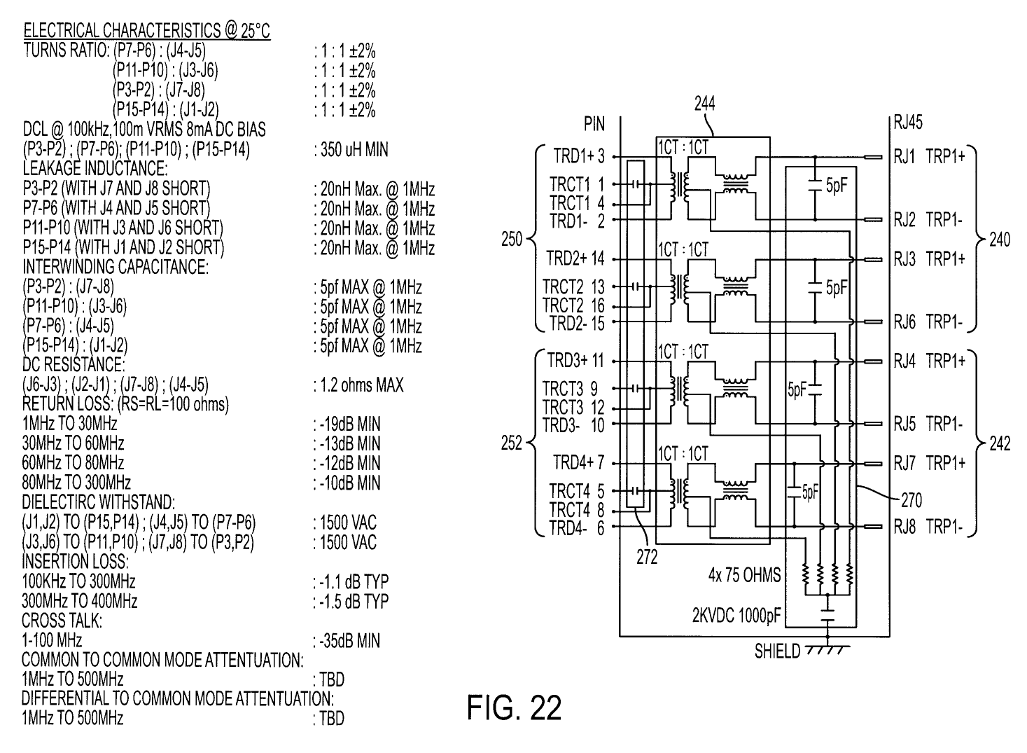

Referring to FIG. 22, there is shown an example of circuit which may be used for magnetic filter circuits 244. Also shown is circuitry 270 which may be used to connect terminals 142 and 116′ with input terminals 240, 242, and circuitry 272 which may be used to connect magnetic filter circuits 244 to output terminals 250, 252. Also shown are some tolerances for the circuit elements depicted. Clearly these elements and tolerances may be changed without altering the scope of the invention.

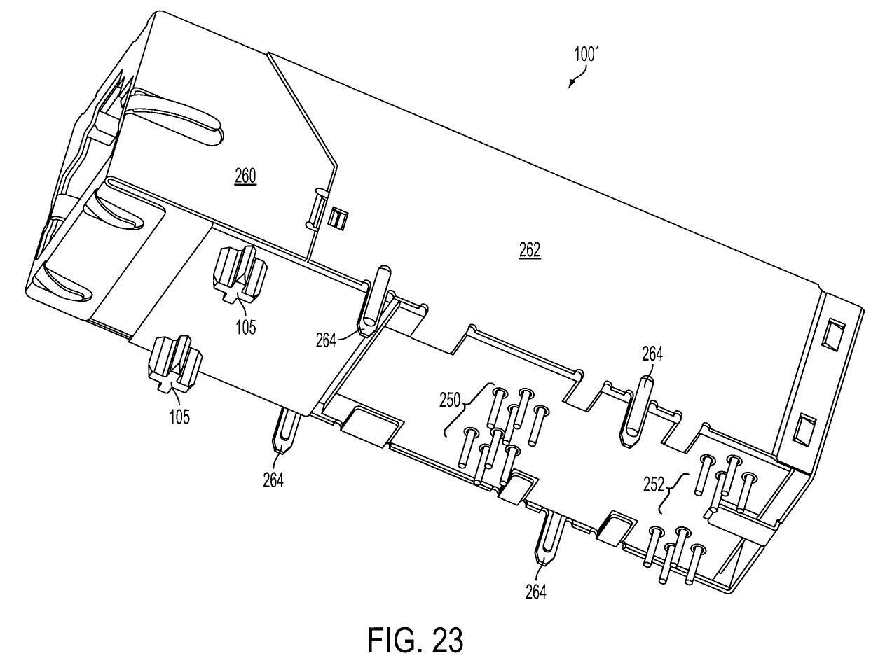

Referring to FIG. 23, there is shown a view of jack 100′ including a shield. As with jack 100, jack 100′ includes a shield front 260, a shield rear 262 and grounding posts 264 used in grounding the shield to a circuit board (not shown).

Having described the preferred embodiments of the invention, it should be noted that the scope of the invention is limited only by the scope of the claims attached hereto and obvious modifications may be made without departing from the scope and spirit of the invention.

What is claimed is:

1. A jack comprising:
a housing;
at least two first contacts on a first side of the housing, each first contact including a contact portion effective to touch a first corresponding contact of a plug when the plug is inserted into the jack, and an end portion effective to be attached to an electronic circuit;
at least two second contacts on a second side of the housing opposite the first side, each second contact including a contact portion effective to touch a second corresponding contact of a plug when the plug is inserted into the jack, and an end portion effective to be inserted into a circuit board;
wherein the ends of the first contacts and the second contacts exit the second side of the housing; and
a shield disposed in the housing between the two first contacts.

2. The jack as recited in claim 1, wherein:
the housing includes a base, a pass-through housing on the base and a support cantilevered from the pass-through housing; wherein the first contacts extend through the support, and through the pass-through housing; and
wherein the shield is disposed in the pass-through housing.

3. The jack as recited in claim 2, wherein the shield is a first shield and the jack further comprises a second shield on the support in between the first contacts.

4. The jack as recited in claim 1, wherein the shield is a first shield and the jack further comprises a second shield disposed between the first contacts and the second contacts.

5. The jack as recited in claim 2, wherein the shield is a first shield and the jack further comprises a second shield disposed between the first contacts in the pass-through housing and the second contacts.

6. The jack as recited in claim 5, wherein the housing defines a plug insertion cavity; and
the second shield is further disposed in the cavity between the first and second contacts.

7. The jack as recited in claim 6, further comprising a third shield disposed on the support in between the first contacts.

8. The jack as recited in claim 1, further comprising a magnetic compensation circuit in the housing.

9. A jack comprising:
a housing;
at least eight first contacts on a first side of the housing, each first contact including a contact portion effective to touch a first corresponding contact of a plug when the plug is inserted into the jack and an end portion effective to be inserted into a circuit board;
at least four second contacts on a second side of the housing opposite the first side, each second contact including a contact portion effective to touch a second corresponding contact of a plug when the plug is inserted into the jack, and an end portion effective to be attached to an electronic circuit;
wherein the ends of the first contacts and the second contacts exit the second side of the housing in first, second, third, and fourth distinct planes, the first plane including the ends of two of the second contacts, the second plane including the ends of another two of the second contacts, the third plane including the ends of four of the first contacts, the fourth plane including the ends of another four of the first contacts.

10. A jack comprising:
a shield including a base and at least one spring member extending toward an inside of the base, the spring member disposed so as to touch a plug shield of a plug when the plug is inserted into the jack;
a housing in the shield;
at least two first contacts on a first side of the housing, each first contact including a contact portion effective to touch a first corresponding contact of a plug when the plug is inserted into the jack, and an end portion effective to be attached to an electronic circuit; and
at least two second contacts on a second side of the housing opposite the first side, each second contact including a contact portion effective to touch a second corresponding contact of a plug when the plug is inserted into the jack, and an end portion effective to be inserted into a circuit board.

11. The jack as recited in claim 10, wherein the shield further includes at least one spring member extending outwardly from the base.

12. The jack as recited in claim 10, wherein the spring member extends inwardly from a top of the base.

13. The jack as recited in claim 10, further comprising a first and a second spring member, the first spring member extends inwardly from a top of the base, the second spring member extends inwardly from a bottom of the base.

14. The jack as recited in claim 10, wherein the spring member extends inwardly from a side of the base.

15. The jack as recited in claim 12, further comprising a first, a second and a third spring member, the first spring member extends inwardly from a top of the base, the second spring member extends inwardly from a bottom of the base, and the third spring member extends inwardly from a side of the base.

16. A method for inserting plugs into a jack, the method comprising:
inserting a first plug including eight contacts all aligned on a first side of the plug into the jack by touching the contacts of the first plug with contacts of the jack, the jack including eight contacts on a first side of the jack and four contacts on a second side of the jack, the contacts of the jack on the first and second sides all having distinct voltage potentials when the plug is not sending electrical signals to the jack;
removing the first plug;
inserting a second plug including contacts aligned on first and second sides of the plug into the jack by touching contacts of the second plug with the contacts of the jack.
